(19) United States
(12) Patent Application Publication
(10) Pub. No.: US 2008/0057988 A1
(43) Pub. Date: Mar. 6, 2008

(54) System and Method for Enhanced Interaction

(75) Inventor: Robert C. Lovell JR., Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: Sybase 365, Inc., Chantilly, VA (US)

(21) Appl. No.: 11/846,183

(22) Filed: Aug. 28, 2007

Related U.S. Application Data
(60) Provisional application No. 60/840,690, filed on Aug. 29, 2006.

(51) Int. Cl. H04Q 7/20

(52) U.S. Cl. 455/466

(57) ABSTRACT

A service that leverages established wireless messaging paradigms such as, possibly inter alia, Short Message Service, Multimedia Message Service, and IP Multimedia Subsystem to yield an infrastructure that allows a Mobile Subscriber to seamlessly employ their Wireless Device to interact with online journals, diaries, etc. such as weblogs or blogs. The service may optionally leverage the capabilities of a centrally-located Value-Added Service Provider.

This application claims the benefit of U.S. Provisional Patent Application No. 60/840,690, filed on Aug. 29, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS), Multimedia Message Service (MMS), Wireless Application Protocol (WAP), Internet Protocol (IP) Multimedia Subsystem (IMS), etc.

2. Background of the Invention

As the ‘wireless revolution’ continues to march forward the importance to a Mobile Subscriber (MS), for example a user of a Wireless Device (WD) such as a mobile telephone, BlackBerry, etc. that is serviced by a Wireless Carrier (WC), of their WD grows substantially.

One consequence of the growing importance of WDs is the resulting ubiquitous nature of WDs—i.e., MSs carry them at almost all times and use them for an ever-increasing range of activities.

Coincident with the growing prevalence of WDs has been the explosive growth of online journals, diaries, etc. such as weblogs or blogs. The blogosphere, the interconnected ‘sum’ of all blogs, continues to expand rapidly and continues to exert its substantial impact on society in general, on mainstream media outlets, etc.

A blog has traditionally been accessed through the World Wide Web (WWW) by an individual user making use of a desktop, laptop, etc. computer.

The present invention extends key elements of wireless messaging technology to provide MSs with alternative channels through which they can easily interact, in rich and complete ways, with blogs and other similarly-situated entities and addresses various of the (not insubstantial) challenges that are associated with same.

### SUMMARY OF THE INVENTION

Embodiments of the present invention provide a service that leverages established wireless messaging paradigms such as, possibly inter alia, SMS, MMS, and IMS to yield an infrastructure that allows a MS to seamlessly employ their WD to interact with online journals, diaries, etc. such as weblogs or blogs.

In an embodiment of the invention a Service Provider (SP) (1) obtains from a blog details about the blog, (2) completes one or more processing steps on the received details (using, possibly inter alia, information that was previously supplied by a MS), and (3) generates one or more update messages and dispatches the update messages to the MS.

Under such an embodiment a SP may obtain details about a blog through, possibly inter alia, a publication/syndication mechanism (such as Really Simple Syndication [RSS]) or actively ‘scraping’ the blog.

Under such an embodiment a SP may (1) receive a reply message from the MS, (2) complete one or more processing steps on the received message to yield one or more posts, and (3) optionally apply some or all of the posts to one or more blogs.

In another embodiment of the invention a SP (1) receives a message from a MS, (2) completes one or more processing steps on the received message to yield one or more posts, and (3) optionally applies some or all of the posts to one or more blogs.

Under such an embodiment a SP may optionally offer one or more value-added services (such as, possibly inter alia, content suggestion and spell checking).

In various of the embodiments a MS may complete a registration process with a SP during which an array of information (including possibly inter alia Identifying Information, Blog Information, Billing Information, Schedules, Filters, and Triggers) may be collected and preserved.

In various of the embodiments the exchanged messages may include, possibly inter alia, SMS, MMS, and/or IMS messages; may be directed to, possibly inter alia, a Short Code (SC) or a Telephone Number (TN); and may contain, possibly inter alia, some combination of graphic elements (e.g., such as a picture or a video clip) and/or textual elements.

In various of the embodiments a SP may complete one or more billing events.

In accordance with still another embodiment of the present invention, there is provided a method for enhanced web log (blog) interaction wherein content from a blog is received, the content is processed using at least in part information previously supplied by a Mobile Subscriber, and one or more update Short Message Service (SMS) messages related to the content are generated and dispatched to the Mobile Subscriber. The method may further include receiving a SMS response from the Mobile Subscriber, where the response results in a comment being posted to the blog. In one possible implementation, the method further includes, in view of the SMS response, suggesting at least one of a quotation and a literary reference for inclusion with the comment.

In yet another embodiment, there is provided a method for providing interaction with an internet web log (blog) that includes receiving at a service provider content created and dispatched via Short Message Service (SMS) from a wireless device of a Mobile Subscriber, and, in response thereto, formatting a blog entry that is posted to a blog. The Mobile Subscriber may be billed for this service. The SMS message may be a reply SMS message.

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 is a diagrammatic presentation of an exemplary Value-Added Service Provider (VASP).

FIG. 2 illustrates one particular arrangement that is possible through aspects of the present invention.

FIG. 3 illustrates various of the exchanges or interactions that are supported by aspects of the present invention.

FIG. 4 is a diagrammatic presentation of aspects of an exemplary SP Application Server (AS).

It should be understood that these figures depict embodiments of the invention. Variations of these embodiments will be apparent to persons skilled in the relevant art(s) based on the teachings contained herein.

### DETAILED DESCRIPTION

The present invention may leverage the capabilities of a centrally-located, full-featured VASP facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a VASP, a summary of various of the services/functions/etc. that are performed by a VASP, and a discussion of the numerous advantages that arise from same. The disclosure of U.S. Pat. No. 7,154,901 is incorporated herein by reference.

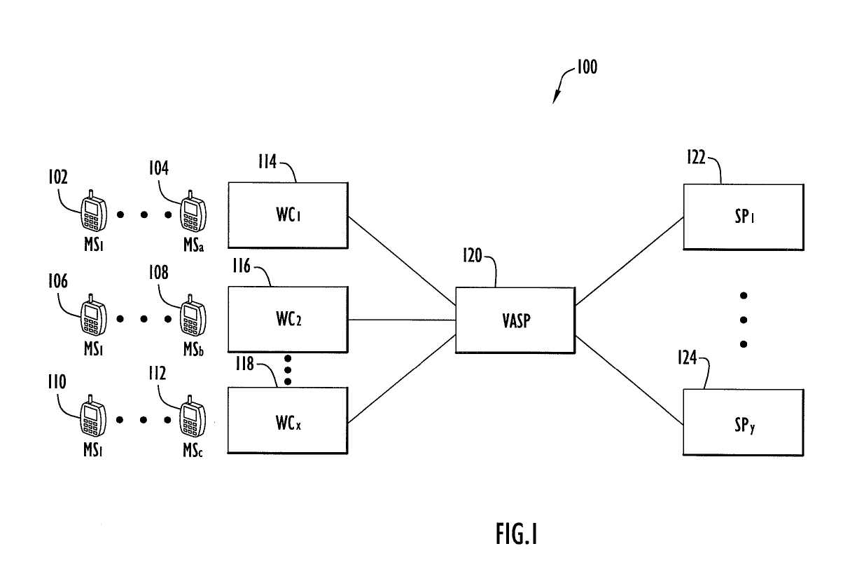

As illustrated by FIG. 1 and reference numeral 100 a VASP 120 is disposed between, possibly inter alia, multiple WCs (WC₁ 114→WCₓ 118) on one side and multiple SPs (SP₁ 122→SP_{y} 124) on the other side and thus ‘bridges’ all of the connected entities. A VASP 120 thus, as one simple example, may offer various routing, formatting, delivery, value-add, etc. capabilities that provide, possibly inter alia:

1) A WC, WC₁ 114→WCₓ 118 (and by extension all of the MSs [MS₁ 102→MSₐ 104, MS₁ 106→MS_{b} 108, MS₁ 110→MS_{c} 112] that are serviced by a WC [WC₁ 114→WCₓ 118]), with ubiquitous access to a broad universe of SPs (SP₁ 122→SP_{y} 124), and

2) A SP (SP₁ 122→SP_{y}124) with ubiquitous access to a broad universe of WCs (WC₁ 114→WCₓ 118 and, by extension, to all of the MSs [MS₁ 102→MSₐ 104, MS₁ 106→MS_{b} 108, MS₁ 110→MS_{c} 112] that are serviced by a WC [WC₁ 114→WCₓ 118]).

Generally speaking a VASP may have varying degrees of visibility (e.g., access, etc.) to the (MS←→MS, MS←→SP, etc.) messaging traffic:

1) A WC may elect to route just their out-of-network messaging traffic to a VASP. Under this approach the VASP would have visibility (e.g., access, etc.) to just the portion of the WC's messaging traffic that was directed to the VASP by the WC.

2) A WC may elect to route all of their messaging traffic to a VASP. The VASP may, possibly among other things, subsequently return to the WC that portion of the messaging traffic that belongs to (i.e., that is destined for a MS of) the WC. Under this approach the VASP would have visibility (e.g., access, etc.) to all of the WC's messaging traffic.

While the discussion below will include a VASP it will be readily apparent to one of ordinary skill in the relevant art that numerous other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a VASP, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a VASP, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a VASP; a VASP and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP SPₓ offers a service that has been enhanced or augmented as provided through the instant invention and Mary, a MS, uses SPₓ's service.

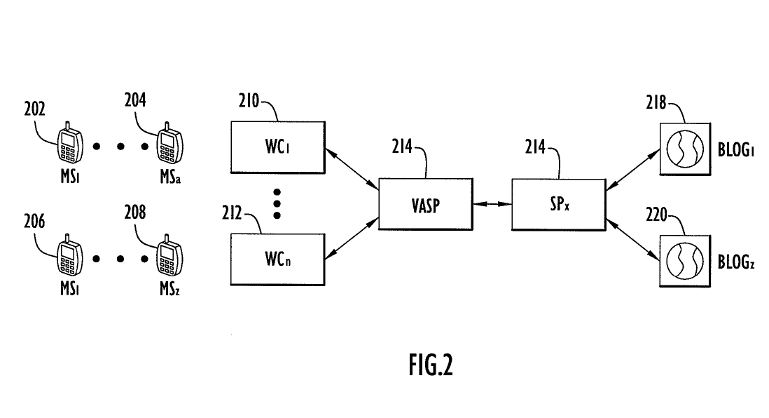

FIG. 2 and reference numeral 200 depicts one possible arrangement under which our hypothetical example might operate. In brief, a number of MSs (MS₁ 202→MSₐ 204 and MS₁ 206→MS_{z} 208, including Mary) may interact, in rich and complete ways, with a range of blogs (Blog₁ 218→Blog_{z} 220) through the services, capabilities, etc. that are offered by SPₓ 216.

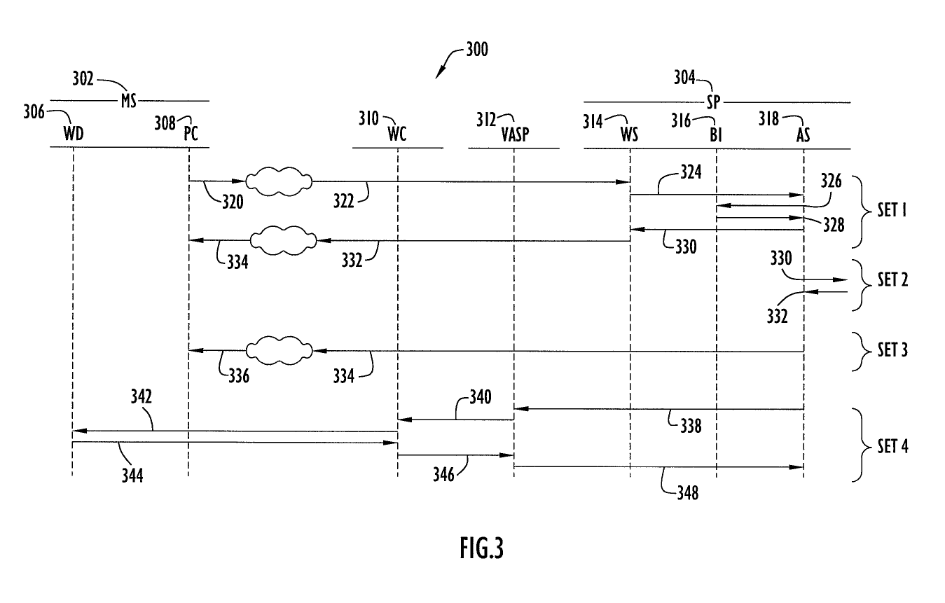

FIG. 3 and reference numeral 300 illustrates various of the exchanges or interactions that might occur under a portion of our hypothetical example. Of interest and note in the diagram are the following entities:

MS 302 WD 306. For example, Mary's WD such as a cellular telephone, BlackBerry, PalmPilot, etc.

MS 302 Personal Computer (PC) 308. For example, one of Mary's home, work, etc. PCs.

WC 310. The provider of service for Mary's WD.

VASP 312. As noted above the use of a VASP, although not required, provides significant advantages.

SP 304 Web Server (WS) 314. A publicly-available WWW site that is optionally provided by SPₓ.

SP 304 Billing Interface (BI) 316. A single, consolidated interface that SPₓ may use to easily reach, inter alia, one or more external entities such as a credit card or debit card clearinghouse, a carrier billing system, a service bureau that provides access to multiple carrier billing systems, etc.

SP 304 AS 318. Facilities that provide key elements of the instant invention (which will be described below).

It is important to note that while in FIG. 3 the MS 302 WD 306 and MS 302 PC 308 entities are illustrated as being adjacent or otherwise near each other in actual practice the entities may, for example, be physically located anywhere.

It is important to note or observe that:

1) In the instant example the messages are shown traversing a VASP 312.

2) The SP 304 may employ a SC or a regular TN as its source address (and to which it would ask users of its service to direct any messages). While the abbreviated length of a SC (e.g., five digits for a SC administered by Neustar under the Common Short Code [CSC] program) incrementally enhances the experience of a MS 302 (e.g., the MS need remember and enter only a few digits as the destination address of a message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

In FIG. 3 the exchanges that are collected under the designation Set 1 represent the activities that might take place as Mary 302 completes a registration process with SPₓ 304. For example:

A) Mary 302 uses one of her PCs 308 to visit a WS 314 of SPₓ 304 to, possibly among other things, complete a service registration process (320→322).

B) The WS 314 interacts with an AS 318 of SPₓ 304 to, possibly among other things, commit some or all of the information that Mary 302 provided to a data repository (e.g., a database), optionally complete a billing transaction, etc. (324).

C) As appropriate and as required a BI 316 of SPₓ 304 completes a billing transaction (326→328).

D) The WS 314 responds appropriately (e.g., with the presentation of a confirmation message, etc.) (332→334).

The specific exchanges that were described above (as residing under the designation Set 1) are illustrative only and it will be readily apparent to one of ordinary skill in the relevant art that numerous other exchanges are easily possible and indeed are fully within the scope of the present invention. As just one example, the registration process may be completed through any combination of one or more channels including, inter alia, the indicated WWW facility, wireless messaging (SMS, MMS, IMS, etc.), E-mail messages, Instant Messaging (IM) exchanges, conventional mail, telephone, Interactive Voice Response (IVR) facilities, etc.

During the registration process that was described above a range of information may be captured from a MS including, inter alia:

1) Identifying Information (e.g., general information about Mary). For example, possibly among other things, a unique identifier and a password, optionally a pseudonym or handle, name, address, age, etc.

2) Blogs (e.g., information about each of the blogs that Mary wishes to interact with). For example, for each blog details such as, inter alia, name; location (e.g., a Uniform Resource Locator [URL]); access credentials (e.g., user identifier and password); publication or syndication details (e.g., RSS); specific threads, chapters, categories, etc. within the blog that are of interest to Mary; etc.

3) Billing Information. Different service billing models may be offered by SPₓ including, possibly inter alia, free (e.g., possibly advertising-based), a fixed one-time charge, a recurring (hourly, daily, monthly, etc.) fixed charge, a recurring (hourly, daily, monthly, etc.) variable charge, a per-use charge, etc. Different payment mechanisms may be supported by SPₓ including, possibly among other things, credit or debit card information, authorization to place a charge on a MS's phone bill, etc.

4) Schedules. For example, possibly inter alia, the particulars (e.g., date, time, frequency, etc.) for the retrieval of content from a specific blog; the particulars (e.g., date, time, frequency, etc.) for the generation of one or more status, update, etc. reports to Mary; etc.

5) Filters. For example, possibly inter alia, the rules, logic, constraints, etc. that are to be applied to each piece of content that is received/retrieved from a blog.

6) Triggers. For example, possibly inter alia, criteria (such as, e.g., keywords, accumulated statistics, etc.) that are to govern the triggering of an action, event, alert, etc.

The specific pieces of information that were described above are illustrative only and it will be readily apparent to one of ordinary skill in the relevant art that numerous other pieces of information are easily possible and indeed are fully within the scope of the present invention.

As noted above the information that Mary provided during the registration process may be preserved in a data repository (e.g., a database) and may optionally be organized as a MS Profile.

The content of Mary's profile may optionally be augmented by SPₓ. For example, one or more internal or external sources of consumer, demographic, psychographic, etc. information may be leveraged to selectively enhance or augment elements of Mary's profile.

As noted above, a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION,” which is incorporated herein by reference. Other ways of completing or performing line item billing are easily implemented by those skilled in the art.

2) The charging of a credit card or the debiting of a debit card.

In FIG. 3 the exchanges that are collected under the designation Set 2 represent the activities that might take place as SPₓ 304 registers, coordinates, etc. with a blog to, possibly among other things, secure access, arrange to receive updates, etc. (330→332).

The specific exchanges that were described above (as residing under the designation Set 2) are illustrative only and it will be readily apparent to one of ordinary skill in the relevant art that numerous other exchanges (including, inter alia, a blog optionally explicitly confirming with a MS their desire/acceptance before beginning to provide access; updates to various of the information in a MS Profile in a SP's repository; a SP dispatching one or more test messages to each of the blogs that were identified during the registration process; etc.) are easily possible and indeed are fully within the scope of the present invention.

In FIG. 3 the exchanges that are collected under the designation Set 3 represent the activities that might take place as SPₓ 304 dispatches to Mary 302 one or more confirmation E-mail messages (334→336).

The specific exchanges that were described above (as residing under the designation Set 3) are illustrative only and it will be readily apparent to one of ordinary skill in the relevant art that numerous other exchanges (including, inter alia, other types or forms of confirmation messages) are easily possible and indeed are fully within the scope of the present invention.

In FIG. 3 the exchanges that are collected under the designation Set 4 represent the activities that might take place as an AS 318 of SPₓ 304 dispatches one or more confirmation SMS, MMS, IMS, etc. messages to Mary's 302 WD 306 (338→342) and Mary 302 replies or responds to the message(s) (344→348). In the instant example the messages are shown traversing a VASP 312. The SP 304 may employ, possibly inter alia, a SC or a regular TN as its source address (and to which it would ask users of its service to direct any reply messages).

The specific exchanges that were described above (as residing under the designation Set 4) are illustrative only and it will be readily apparent to one of ordinary skill in the relevant art that numerous other exchanges are easily possible and indeed are fully within the scope of the present invention.

The Set 1, Set 2, Set 3, and Set 4 exchanges that were described above are illustrative only and it will be readily apparent to one of ordinary skill in the relevant art that numerous other exchanges are easily possible and indeed are fully within the scope of the present invention.

The information that was described above may be subsequently managed (e.g., existing information may be edited or removed, new information may be added, etc.) through any combination of one or more channels including, inter alia, a SP's WWW facility, wireless messaging (SMS, MMS, IMS, etc.), E-mail messages, IM exchanges, conventional mail, telephone, IVR facilities, etc.

To continue with our hypothetical example . . . After completing the registration process SPₓ may begin to receive information (via, for example, a publication/syndication mechanism) from, and/or actively retrieve, ‘scrape,’ etc. information from, various of the blogs that were specified by Mary. SPₓ may optionally preserve some or all of the collected content within, for example, one of its database, etc. environments.

SPₓ may optionally pass the collected content against any filters and/or triggers that Mary had previously defined. SPₓ may optionally preserve some or all of the results of such operations within, for example, one of its database, etc. environments.

Mary may begin to receive information or content updates from SPₓ—e.g., based on a schedule that was previously defined by Mary, when one or more triggers or thresholds that were previously defined by Mary are realized, on-demand (i.e., in response to an explicit request from Mary), etc. SPₓ may optionally preserve some or all of the dispatched updates within, for example, one of its database, etc. environments. These updates may be communicated to Mary in the form of SMS, MMS, IMS, etc. messages.

Mary may optionally respond to a received update. Such a response may result in, possibly inter alia, SPₓ generating, processing, formatting, etc. a comment and that comment being posted to the appropriate section, etc. of the associated blog. SPₓ may optionally preserve some or all of any such responses (along with any resulting comments, etc.) within, for example, one of its database, etc. environments.

Mary may optionally create on her WD new material and dispatch that material to SPₓ resulting in, possibly inter alia, SPₓ generating, processing, formatting, etc. a new blog entry and that entry being posted to the appropriate section, etc. of the indicated blog. SPₓ may optionally preserve some or all of any such new material (along with any resulting blog entries, etc.) within, for example, one of its database, etc. environments.

Mary may optionally have SPₓ examine the content of her responses and/or new entries and provide one or more value-add services, including (possibly inter alia):

1) Suggest or recommend elements (such as, for example, opinions, facts, quotations, literary references, etc.) for possible inclusion. In support of such activity SPₓ may refer to one or more internally-maintained heuristics, metrics, etc. (e.g., that measure or otherwise gauge the content, mood, direction, etc. of a blog posting and/or of comments to a blog posting, etc.), may leverage one or more internal and/or external data sources (such as, for example, dictionaries, encyclopedias, reference volumes, WWW sites, etc.), etc.

2) Perform activities such as spell checking, etc.

SPₓ may optionally examine the content of some or all of the inbound and/or outbound messages to dynamically generate, based on configurable rules/logic/data/etc. that may in part be defined by specific (e.g., registered) blogs/advertisers/etc., one or more alert messages that may be dispatched to MSs, blogs, advertisers, etc. SPₓ may optionally preserve some or all of any such activities (along with any resulting alerts, etc.) within, for example, one of its database, etc. environments.

SPₓ may optionally generate scheduled (e.g., daily, weekly, etc.) and/or on-demand activity, status, result, etc. reports with generated reports delivered through SMS, MMS, IMS, etc. messages; through e-mail; through a Web-based facility; etc.

SPₓ may optionally perform one or more incremental billing operations as it completes, for example, the various processing activities that were described above. An incremental billing operation may be triggered by configurable thresholds such as, possibly inter alia, total inbound and/or outbound message count, individual or aggregate inbound and/or outbound message volume, a blog-specific fee or charge, value-add services provided, etc. SPₓ may optionally preserve some or all of any such activities within, for example, one of its database, etc. environments.

SPₓ may optionally allow advertisers to register and/or provide (e.g., directly, or through links/references to external sources) advertising content.

The (confirmation, reply, update, response, alert, etc.) message(s) that were described above may optionally contain an informational element—e.g., a public service announcement, a relevant or applicable factoid, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Global Positioning System (GPS)/Location-Based Services (LBS) facility).

The message(s) that were described above may optionally contain advertising—e.g., textual material if an SMS model is being utilized, multimedia (images of brand logos, sound, video snippets, etc.) material if an MMS model is being utilized, etc. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a GPS/LBS facility).

The message(s) that were described above may optionally contain promotional materials (e.g., text, still images, video clips, etc.).

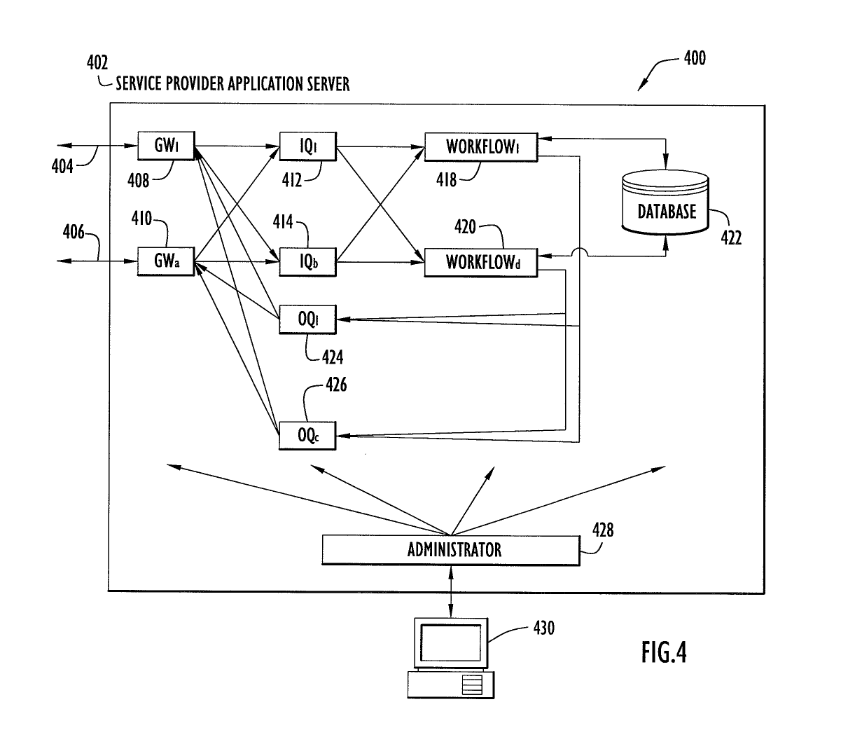

FIG. 4 and reference numeral 400 provide a diagrammatic presentation of aspects of an exemplary SP AS 402. The illustrated AS 402 contains several key components—Gateways (GW₁ 408→GWₐ 410 in the diagram), Incoming Queues (IQ₁ 412→IQ_{b} 414 in the diagram), WorkFlows (WorkFlow₁ 418→WorkFlow_{d} 420 in the diagram), Database 422, Outgoing Queues (OQ₁ 424→OQ_{c} 426 in the diagram), and an Administrator 428. It will be readily apparent to one of ordinary skill in the relevant art that numerous other components are possible within an AS 402.

A dynamically updateable set of one or more Gateways (GW₁ 408→GWₐ 410 in the diagram) handle incoming (e.g., SMS/MMS/IMS/etc. messaging, blog, etc.) traffic and outgoing (e.g., SMS/MMS/IMS/etc. messaging, blog, etc.) traffic. Incoming traffic is accepted and deposited on an intermediate or temporary Incoming Queue (IQ₁ 412→IQ_{b} 414 in the diagram) for subsequent processing. Processed artifacts are removed from an intermediate or temporary Outgoing Queue (OQ₁ 424 OQ_{c} 426 in the diagram) and then dispatched.

A dynamically updateable set of one or more Incoming Queues (IQ₁ 412→IQ_{b} 414 in the diagram) and a dynamically updateable set of one or more Outgoing Queues (OQ₁ 424→OQ_{c} 426 in the diagram) operate as intermediate or temporary buffers for incoming and outgoing traffic.

A dynamically updateable set of one or more WorkFlows (WorkFlow₁ 418→WorkFlow_{d} 420 in the diagram) remove incoming traffic from an intermediate or temporary Incoming Queue (IQ₁ 412→IQ_{b} 414 in the diagram), perform all of the required processing operations (more about this below), and deposit processed artifacts on an intermediate or temporary Outgoing Queue (OQ₁ 424→OQ_{c} 426 in the diagram).

The Database 422 that is depicted in FIG. 4 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

As depicted in FIG. 4 an Administrator 428 provides management or administrative control over all of the different components of an AS 402 through, as one example, a WWW-based interface 430. It will be readily apparent to one of ordinary skill in the relevant art that numerous other interfaces (e.g., a data feed, an Application Programming Interface [API], etc.) are easily possible.

Through flexible, extensible, and dynamically updatable configuration information a WorkFlow component may be quickly and easily realized to support any number of activities. For example, WorkFlows might be configured to support the registration of a MS; the extraction of data values from an incoming message; the editing/validation of data values; the enhancement/augmentation of data values; an array of analysis operations; the generation and dispatch of reply messages; the generation of scheduled and/or on-demand reports; the interaction with a blog; the interaction with external and/or internal sources of data or information; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, etc. activities may be recorded. Among other things, such a repository may be used to support:

1) Scheduled (e.g., daily, weekly, etc.) and/or on-demand reporting with report results delivered through SMS, MMS, IMS, etc. messages; through E-Mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered through SMS, MMS, IMS, etc. messages; through E-Mail; through a WWW-based facility; etc.

It is important to note that while aspects of the discussion that was presented above focused on the use of SCs, it will be readily apparent to one of ordinary skill in the relevant art that TNs and other message address identifiers are equally applicable and, indeed, are fully within the scope of the present invention.

The discussion that was just presented referenced the specific wireless messaging paradigms SMS and MMS. These paradigms potentially offer an incremental advantage over other paradigms in that native support may commonly be found on a WD that a potential MS would be carrying. However, it is to be understood that it would be readily apparent to one of ordinary skill in the relevant art that other paradigms (IMS, WAP, etc.) are fully within the scope of the present invention.

The foregoing disclosure of the preferred embodiments of the present invention, which was described in the narrative and which was illustrated in the accompanying figures, has been presented for purposes of illustration and description. It is not intended to be exhaustive or to limit the invention to the precise forms disclosed. It will be readily apparent to one of ordinary skill in the relevant art that numerous alternatives to the presented embodiments are easily possible and, indeed, are fully within the scope of the present invention.

The following list defines acronyms as used in this disclosure.

| Acronym | Meaning |
|---|---|
| API | Application Programming Interface |
| AS | Application Server |
| BI | Billing Interface |
| CSC | Common Short Code |
| DBMS | Database Management System |
| E-Mail | Electronic Mail |
| GIS | Geographic Information System |
| GPS | Global Positioning System |
| GW | Gateway |
| IM | Instant Messaging |
| IMS | IP Multimedia Subsystem |
| IP | Internet Protocol |
| IQ | Incoming Queue |
| IVR | Interactive Voice Response |
| LBS | Location-Based Service |
| MMS | Multimedia Message Service |
| MS | Mobile Subscriber |
| ODBMS | Object Database Management System |
| OQ | Outgoing Queue |
| PC | Personal Computer |
| RDBMS | Relational Database Management System |
| RSS | Really Simple Syndication |
| SC | Short Code |
| SMS | Short Message Service |
| SP | Service Provider |
| TN | Telephone Number |
| URL | Uniform Resource Locator |
| VASP | Value-Added Service Provider |
| WAP | Wireless Application Protocol |
| WC | Wireless Carrier |
| WD | Wireless Device |
| WF | WorkFlow |
| WS | Web Server |
| WWW | World Wide Web |

What is claimed is:

1. A method for enhanced web log (blog) interaction, comprising:
receiving content from a blog;
processing said content using at least in part information previously supplied by a Mobile Subscriber; and
generating and dispatching one or more update Short Message Service (SMS) messages related to the content to said Mobile Subscriber.

2. The method of claim 1, further comprising receiving a SMS response from the Mobile Subscriber, the response resulting in a comment being posted to the blog.

3. The method of claim 2, further comprising, in view of the SMS response, suggesting at least one of a quotation and a literary reference for inclusion with the comment.

4. The method of claim 1, wherein said content is received via Really Simple Syndication.

5. The method of claim 4, wherein said content is received continuously.

6. The method of claim 4, wherein said content is received periodically on a scheduled basis.

7. The method of claim 1, wherein said content is retrieved via ‘screen scraping.’

8. The method of claim 1, wherein said information is defined by a Mobile Subscriber during a registration process.

9. The method of claim 8, wherein said information includes one or more of Identifying Information, Blog Information, Billing Information, Schedules, Filters, and Triggers.

10. The method of claim 8, wherein said information is preserved through a User Profile.

11. The method of claim 8, wherein said registration process is Web-based.

12. The method of claim 8, wherein said registration process includes a billing component.

13. The method of claim 1, further comprising at least one of applying Filter criteria and causing a Trigger action.

14. The method of claim 1, wherein said update SMS messages contain advertising and/or promotional material.

15. A method for enhanced web log (blog) interaction, comprising:
receiving from a Mobile Subscriber a Short Message Service (SMS) message including content;
processing said SMS message to yield one or more posts based on the content; and
applying some or all of said posts to one or more blogs.

16. The method of claim 15, further including providing a value-added service to said content.

17. The method of claim 16, wherein said value-added service includes spell checking.

18. The method of claim 16, wherein said value-added service includes a content suggestion.

19. The method of claim 16, wherein said value-added service results in an incremental billing.

20. The method of claim 15, further comprising generating, in view of the content, an alert message to a plurality of Mobile Subscribers.

21. A method for providing interaction with an internet web log (blog), comprising:
receiving at a service provider content created and dispatched via Short Message Service (SMS) from a wireless device of a Mobile Subscriber, and, in response thereto, formatting a blog entry that is posted to a blog.

22. The method of claim 21, further comprising billing the Mobile Subscriber.

23. The method of claim 21, wherein the content is part of a reply SMS message.
